(19) United States
(12) Patent Application Publication
(10) Pub. No.: US 2019/0186460 A1
(43) Pub. Date: Jun. 20, 2019

(54) ROTATIONAL GENERATOR

(71) Applicant: Tony Petkovic, Vancouver (CA)

(72) Inventor: Tony Petkovic, Vancouver (CA)

(21) Appl. No.: 15/849,415

(22) Filed: Dec. 20, 2017

(51) Int. Cl. F03B 17/02; F03G 3/00

(52) U.S. Cl. CPC F03B 17/02; F05B 2240/30; F03G 3/00

(57) ABSTRACT

A rotating apparatus comprising a base, at least two elongate retaining arms extending a length between first and second ends, each of the at least two retaining arms rotatably supported by the base along a horizontal axis proximate to the second end and a slot extending through each of the at least two retaining arms from the first end of each of the at least two retaining arms. The apparatus further comprises a ball retained within the slot, and a concave ball guide secured to the base wherein the concave ball guide is passed through the slot as the at least two retaining arms are moved therepast.

### BACKGROUND OF THE INVENTION

### 1. Field of Invention

The present invention relates generally to rotating devices and in particular to a rotating device driven by a plurality of balls.

### 2. Description of Related Art

There exists a need to produce power and/or movement for a vehicle. There exists a growing need around the world to provide sources of energy which are readily available and produce low or no pollution. Disadvantageously, many current forms of energy are expensive and may be sources of pollution.

The use of buoyancy or gravity to provide lift and therefore power have been previously proposed. However such previous attempts have not been successful as either too complicated or lacking scalability. In particular, some attempts have been proposed which utilize buoyant or weighted balls which move in a track or circuit to provide energy or lift. Examples of such devices may be found in U.S. Pat. No. 8,516,812 to Manakkattupadeettathil or U.S. Pat. No. 6,734,574 to Shin. Such solutions are extremely complicated and impractical for use on a vehicle.

Further other proposed solutions have linked a plurality of buoyant bodies together. Examples of such devices may be found in U.S. Pat. No. 5,944,480 to Forrest. Disadvantageously, as the buoyant bodies in such devices are connected to the rest of the apparatus only be strings or the like, such a device would be prone to excessive movement of the bodies during movement of the apparatus.

### SUMMARY OF THE INVENTION

According to a first embodiment of the present invention there is disclosed a rotating apparatus comprising a base, at least two elongate retaining arms extending a length between first and second ends, each of the at least two retaining arms rotatably supported by the base along a horizontal axis proximate to the second end and a slot extending through each of the at least two retaining arms from the first end of each of the at least two retaining arms. The apparatus further comprises a ball retained within the slot, and a concave ball guide secured to the base wherein the concave ball guide is passed through the slot as the at least two retaining arms are moved therepast.

The at least two retaining arms may comprise two retaining arms. The two retaining arms may extend along a common axis.

The apparatus may further comprise a convex ball guide extending between fixed and free ends wherein the fixed end may be secured to the concave ball guide. The convex ball guide may extend through the slot as the at least two retaining arms are moved therepast.

The apparatus may further comprise a vertical ball passage between the concave ball guide and the fixed end of the convex ball guide. The vertical ball passage may be adapted to permit the ball to pass therethrough.

The slot may include a widened portion adapted to permit the vertical ball passage to pass therethrough as the at least two retaining arms are moved therepast. The free end may be horizontally spaced apart from the fixed end.

The convex ball guide may have a length adapted to move the ball within the slot to a position proximate to the free end and the first end of the at least two retaining arms as the at least two retaining arms are moved therepast.

The ball may be buoyant. The horizontal axis may be submerged within a fluid at a depth less than the length of each of the at least two retaining arms. The ball may be weighted.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a side view of a rotating apparatus according to a first embodiment of the invention partially submerged within a body of water.

FIG. 2 is a cross sectional view of the rotating apparatus taken along the line 2-2 of FIG. 1.

FIG. 3 is an end view of the apparatus of FIG. 1.

FIG. 4 is a side view of the apparatus of FIG. 1 in a rotated position.

FIG. 5 is a side view of the apparatus of FIG. 1 in a rotated position.

FIG. 6 is a side view of the apparatus of FIG. 1 utilizing weighted balls according to a further embodiment of the present invention.

FIG. 7 is a perspective view of a rotating apparatus according to a further embodiment having a plurality of radially staggered arms.

### DETAILED DESCRIPTION

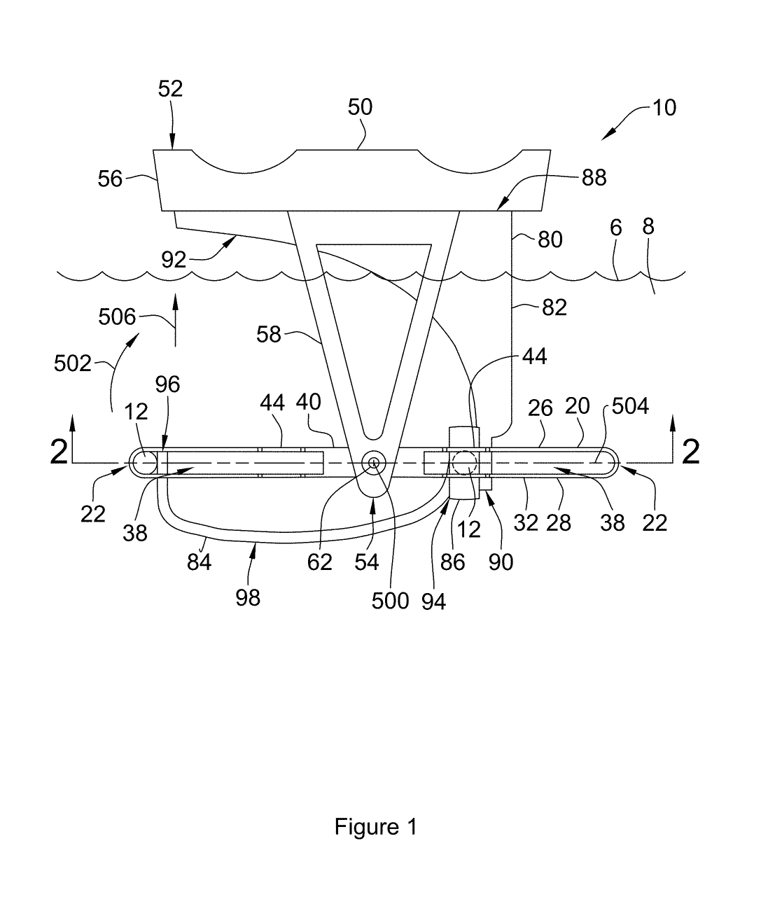

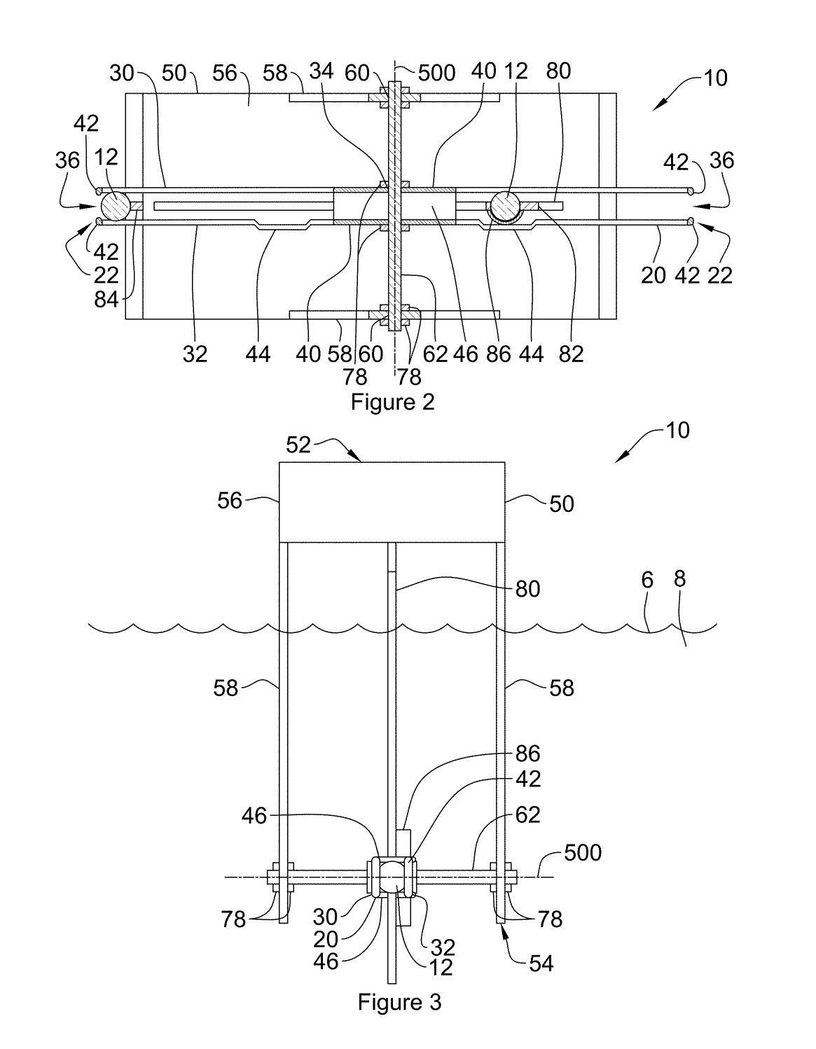

Referring to FIGS. 1 and 2, a rotating apparatus according to a first embodiment of the invention is shown generally at 10, partially submerged in a body of water 8 with a surface 6. The apparatus 10 includes a retaining arm assembly 20 rotatably supported about a horizontal axis 500 by a base 50. As the retaining arm assembly 20 rotates about the axis 500 in a direction indicated at 502, a pair of balls 12 retained within the retaining arm assembly 20 are guided within the retaining arm assembly 20 by a ball guide assembly 80, as will be set out it further detail below.

Referring to FIGS. 1 through 3, the base 50 extends between top and bottom edges, 52 and 54, respectively, and includes a top portion 56 proximate to the top edge 52 and a pair of retaining arm supports 58 extending from the top portion 56 to the bottom edge 54. Each retaining arm support 58 includes a bore 60 extending along the axis 500 adapted to receive a shaft 62 therethrough.

The retaining arm assembly 20 extends between arcuate ends 22 and the horizontal axis 500, and between first and second edges, 26 and 28, respectively. As illustrated, the retaining arm assembly 20 may include two ends 22 such that the retaining arm assembly 20 extends along an axis 504 between each arcuate end 22 and the horizontal axis 500 although each retaining arm assembly 20 may also be formed as only a single length extending radially from the horizontal axis 500. The retaining arm assembly 20 is comprised of first and second side retainers, 30 and 32, respectively, joined by a pair of central planar joining members 46 extending therebetween spaced apart and parallel to the horizontal axis 500, as best seen in FIG. 3. Each retainer 30 and 32 includes a planar center portion 40 with a bore 34 therethrough at the horizontal axis 500, adapted to receive the shaft 62 therethrough. The retaining arm assembly 20 is secured to the shaft 62 with a pair of shaft collars 78 secured thereto, as is commonly known. The shaft 62 is rotatably secured to the retaining arm supports 58 with additional shaft collars 78.

As best seen in FIG. 2, the retaining arm assembly 20 includes slots 36 extending from the ends 22 between the first and second retainers 30 and 32. As best seen in FIG. 1, each retainer 30 and 32, includes a gap 38 extending from proximate the ends 22 to the center portion 40. The ends 22 may include flexible lips 42 extending partially into the slots 36. As illustrated in FIGS. 1 and 3, the retaining arm assembly is formed as a wire frame. The balls 12 are retained between the first and second retainers 30 and 32, and are adapted to move longitudinally within the slots 36 and the gaps 38, as will be set out in further detail below. The second retainer 32 includes expanded portions 44 proximate to the center portion 40, the purpose of which will be set out below. Referring to FIG. 1, the ball guide assembly 80 includes a concave ball guide 82 and a convex ball guide 84 with a vertical ball passage connector 86 therebetween. The ball guide assembly 80 is adapted to be received within the slots 36 of the retaining arm assembly 20 as the retaining arm assembly 20 is rotated therepast, as will be set out further below.

The concave ball guide 82 extends between top and bottom edges, 88 and 90, respectively, and includes a concave ball guide surface 92. The convex ball guide 84 extends between horizontally spaced apart fixed and free ends, 94 and 96, respectively, and includes a convex ball guide surface 98 extending below the horizontal axis 500. The concave ball guide 82 is mounted to the top portion 56 of the base 50 proximate to the top edge 88, by means as are commonly known.

As illustrated in FIGS. 1 and 2, the vertical ball passage connector 86 is secured to the concave ball guide 82 proximate to the bottom edge 90 and to the convex ball guide 84 proximate to the free end 94. The vertical ball passage connector 86 is adapted to pass between the retainers 30 and 32 proximate to the expanded portions 44 of the second retainer 32 as the retaining arm assembly 20 is rotated therepast. The purpose of the vertical ball passage connector 86 is to direct a ball 12 from engagement upon the concave ball guide surface 92 to engagement upon the convex ball guide surface 98. As illustrated in FIG. 2, a ball 12 is engaged upon the concave ball guide 82, the convex ball guide 84 and the vertical ball passage connector 86 as the retaining arm assembly 20 is rotated therepast.

As illustrated in FIGS. 1 and 2, the free end 96 of the convex ball guide 84 is adapted to position the ball 12 within the slot 36 and the gap 38 proximate to an end 22 of the retaining arm assembly 20 as the retaining arm assembly 20 is rotated therepast. The flexible lips 42 are adapted to retain the ball 12 between the free end 96 of the convex ball guide 84 and the end 22, as the retaining arm assembly 20 is rotated therepast, as illustrated in FIGS. 1 and 2.

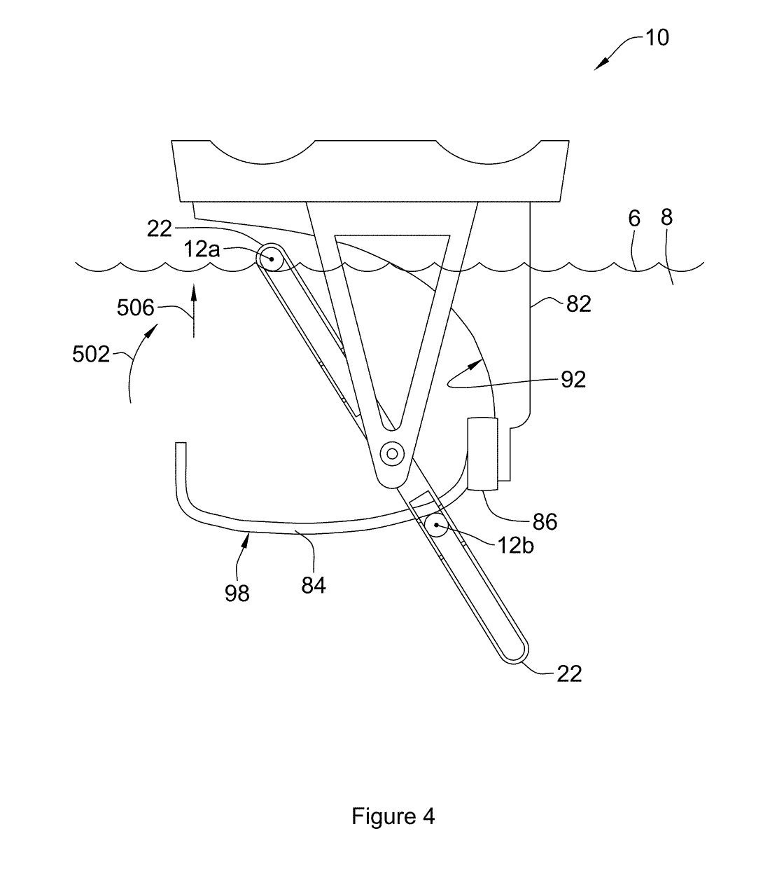

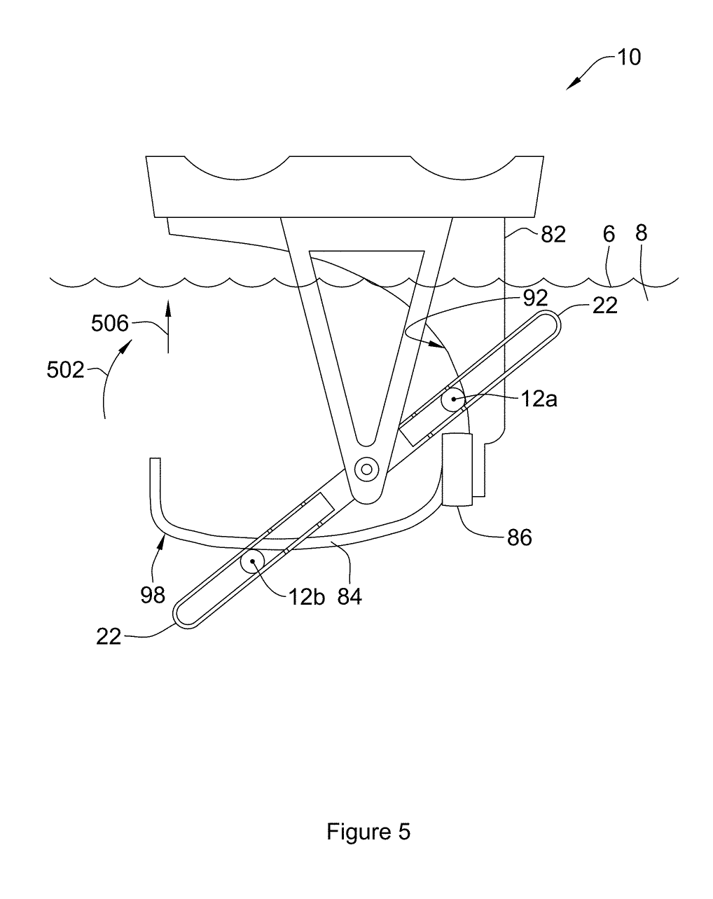

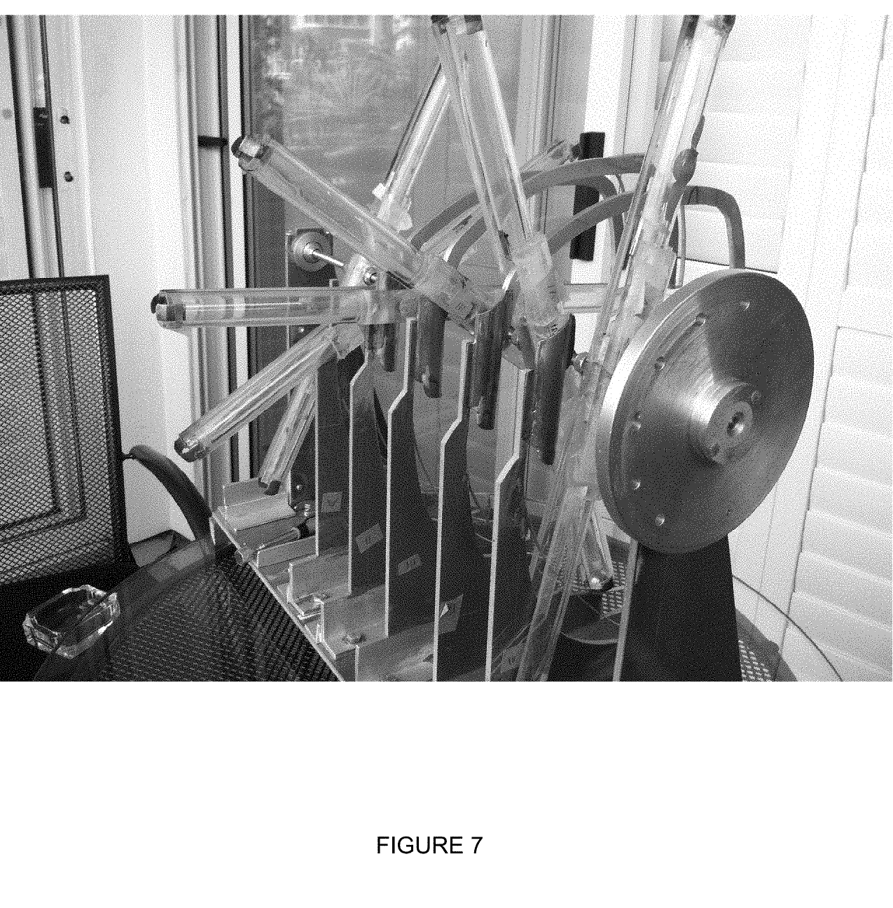

The balls 12 are buoyant and may be formed using such as, by way of non-limiting example, air-tight, hollow plastic. As illustrated in FIGS. 2, 4 and 5, one ball 12 is retained in the retaining arm assembly 20 within each slot 36. As the balls 12 are buoyant and the apparatus 10 is partially submerged in water 8, the buoyant balls 12 are forced upwards towards the surface 6 of the water 8, in the direction indicated at 506. For clarity, each ball 12 is designated as either an upper ball 12a located above the horizontal axis 500 or a lower ball 12b located below the horizontal axis 500. Following an initial application of force to the retaining arm assembly 20 to initiate rotation in the direction indicated at 502, the upper ball 12a passes the free end 96 of the convex ball guide 84 and naturally moves towards the surface 6 of the water 8, thereby rotating the retaining arm assembly 20 in the direction indicated at 502, and moving the lower ball 12b into engagement with the convex ball guide 84, as illustrated in FIG. 4. The momentum of the retaining arm assembly 20 and the longer lever arm between the axis 500 and the upper ball 12a compared to the shorter lever arm between the axis 500 and the lower ball 12b enables the retaining arm assembly 20 to continue to rotate such that the upper ball 12a moves into engagement with the concave ball guide 82 and the lower ball 12b moves along the convex ball guide 84 towards the free end 96. Due to momentum and buoyancy of the balls 12, the retaining arm assembly 20 continues to rotate in the direction indicated at 502. Note that a generator may be attached to the shaft 62 by means as are commonly known to produce electricity while the shaft 62 is rotating, as is commonly known. Optionally, the rotation of the arm assembly 20 may also provide a movement operable to drive a propeller or may include other means of propelling a vehicle. Although a single pair of retaining arm assemblies 20 are illustrated in FIGS. 1-6, it will be appreciated that more than one retaining arm assembly 20 may be located on a common shaft so as to be radially arranged around the shaft as illustrated in FIG. 7.

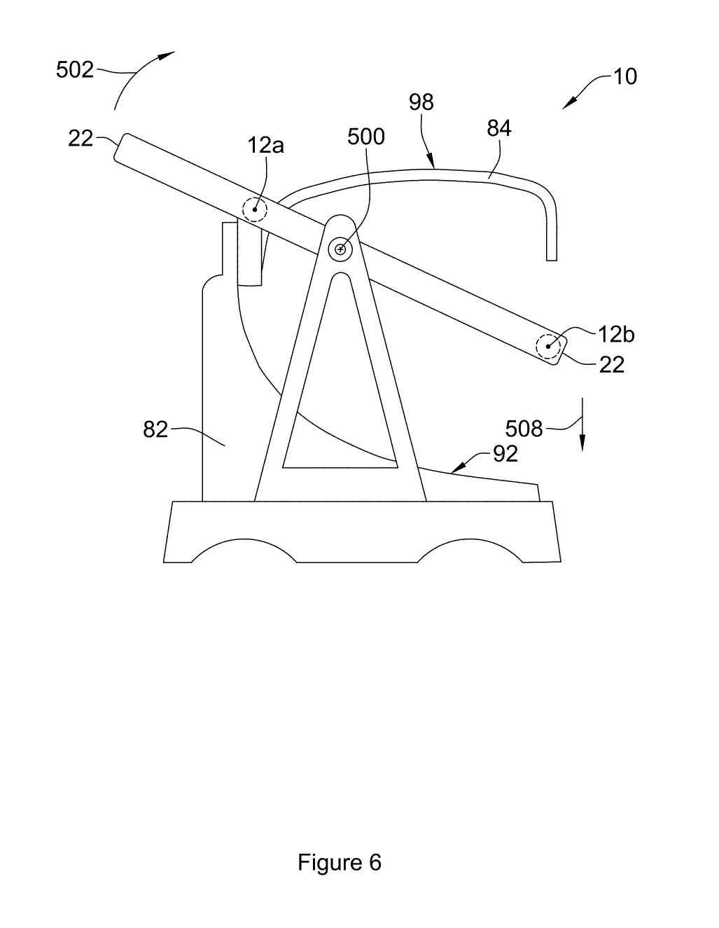

Turning now to FIG. 6, an alternate embodiment of the apparatus 10 is illustrated with weighted balls 12 using the force of gravity in a direction generally indicated at 508 to propel the balls 12. For clarity, a ball located above the horizontal axis 500 is designated as an upper ball 12a while a lower ball 12b is located below the horizontal axis 500. As a ball 12 passes the free end 96 of the convex ball guide 84, the force of gravity 508 naturally moves the lower ball 12b down, thereby rotating the retaining arm assembly 20 about the horizontal axis 500 in the direction indicated at 502. In a similar manner to that described above, the balls 12 alternate between engagement with the concave ball guide 82 and the convex ball guide 84. As illustrated in FIG. 6, the retaining arm assemblies of the gravity driven apparatus may be formed of tubes having slots 36 extending therein as set out above to reduce the effects of air friction upon the balls.

While specific embodiments of the invention have been described and illustrated, such embodiments should be considered illustrative of the invention only and not as limiting the invention as construed in accordance with the accompanying claims.

What is claimed is:

1. A rotating apparatus comprising:
a base;
at least two elongate retaining arms extending a length between first and second ends, each of said at least two retaining arms rotatably supported by said base along a horizontal axis proximate to said second end;
a slot extending through each of said at least two retaining arms from said first end of each of said at least two retaining arms;
a ball retained within said slot; and
a concave ball guide secured to said base wherein said concave ball guide is passed through said slot as said at least two retaining arms are moved therepast.

2. The apparatus of claim 1 wherein said at least two retaining arms comprise two retaining arms.

3. The apparatus of claim 2 wherein said two retaining arms extend along a common axis.

4. The apparatus of claim 1 further comprising a convex ball guide extending between fixed and free ends wherein said fixed end is secured to said concave ball guide.

5. The apparatus of claim 4 wherein said convex ball guide extends through said slot as said at least two retaining arms are moved therepast.

6. The apparatus of claim 5 further comprising a vertical ball passage between said concave ball guide and said fixed end of said convex ball guide.

7. The apparatus of claim 6 wherein said vertical ball passage is adapted to permit said ball to pass therethrough.

8. The apparatus of claim 7 wherein said slot includes a widened portion adapted to permit said vertical ball passage to pass therethrough as said at least two retaining arms are moved therepast.

9. The apparatus of claim 5 wherein said free end is horizontally spaced apart from said fixed end.

10. The apparatus of claim 9 wherein said convex ball guide has a length adapted to move said ball within said slot to a position proximate to said free end and said first end of said at least two retaining arms as said at least two retaining arms are moved therepast.

11. The apparatus of claim 1 wherein said ball is buoyant.

12. The apparatus of claim 11 wherein said horizontal axis is submerged within a fluid at a depth less than said length of each of said at least two retaining arms.

13. The apparatus of claim 1 wherein said ball is weighted.
